(19) United States
(12) Patent Application Publication
(10) Pub. No.: US 2007/0270325 A1
(43) Pub. Date: Nov. 22, 2007

(54) Gel compositions contained in bottom dispensing containers

(76) Inventors: Francesco de Buzzaccarini, Breendonk (BE); Ann De Wree, Oost-Vlaanderen (BE); Filip Dominique Hubert Vangeel, Vilvoorde (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/799,790

(22) Filed: May 3, 2007

Related U.S. Application Data
(60) Provisional application No. 60/798,219, filed on May 5, 2006.

(51) Int. Cl. B67D 5/06; C11D 17/00

(52) U.S. Cl. 510/424; 222/179.5; 222/494; 510/475

(57) ABSTRACT

The present invention relates to gel detergent compositions in bottom dispensing containers.

### CROSS REFERENCE TO RELATED APPLICATION

This application claims the benefit of U.S. Provisional Application Ser. No. 60/798,219, filed May 5, 2006.

### FIELD OF THE INVENTION

The present invention relates to gel detergent compositions in bottom dispensing containers.

### BACKGROUND OF THE INVENTION

Thickened liquid or gel laundry products are preferred by many consumers, over powder detergents. However, one drawback of gels is that when consumer stops dispensing a desired quantity, it is in fact difficult to interrupt the flow. As a result, the detergent continues to drip. A liquid/gel detergent composition which snaps back at the end of pouring is desirable, so as to avoid dripping after dispensing.

Similarly, as laundry products are frequently also used as pretreaters, a property is “pile-up,” i.e. the property of a product, such as a gel, to pile up on the surface of the fabric rather than spreading to a substantially larger area is desirable. The gel laundry products that can pile up are less messy to use and provide better stain removal, in pretreatment since more detergent is concentrated on the desired area of fabric (e.g., the spot or stain).

Furthermore, the need for updated packaging is particularly difficult to satisfy for heavy duty liquid or gel detergents and other liquid consumer products since the liquid product poses challenges to the packaging engineer. For instance, the package must still permit convenient dispensing by consumers, who range in age from children through middle aged adults and up into the older population. In addition, the difficulties in ensuring structural integrity of the package are markedly increased. Moreover, it is desirable to provide such packaging at a low cost to consumers.

Consequently, the need remains for a packaged compact laundry liquid or gel consumer product that provides better stain removal, is convenient or easy to use and is aesthetically appealing to consumers.

### SUMMARY OF THE INVENTION

One aspect of the invention relates to an article of commerce for storing and dispensing gel compositions comprising:
(a) a bottom dispensing container; and
(b) a gel detergent composition releasably stored in the bottom dispensing container, wherein the gel detergent composition comprises:
(i) a surfactant; and
(ii) a non-neutralized fatty acid;
   and wherein the gel detergent composition piles up upon dispensing.

Another aspect of the invention relates to an article of commerce for storing and dispensing gel compositions comprising:
(a) a bottom dispensing container; and
(b) a non-drip gel detergent composition, releasably stored in the bottom dispensing container, wherein the gel detergent composition comprises:
(i) a surfactant; and
(ii) a non-neutralized fatty acid;
   wherein the weight ratio of non-neutralized fatty acid to the surfactant is less than about 1 but greater than or equal to the Snap Index Value, S, defined by equation (II)
   S=0.3−(0.0085×A) (II);
   And wherein A is the total surfactant concentration.

Another aspect of the invention relates to an article of commerce for storing and dispensing gel compositions comprising:
(a) a bottom dispensing container; and
(b) a gel detergent composition, releasably stored in the bottom dispensing container, wherein the gel detergent composition comprises:
(i) a surfactant; and
(ii) a non-neutralized fatty acid;
wherein the weight % ratio of non-neutralized fatty acid to the surfactant is less than about 1 but greater than or equal to the Gelling Index Value, GIV, defined by equation (III)

$$GIV = \frac{0.75}{1 + {( 0.11 ⨯ A )}^{8.3}} - ( 0.0062 ⨯ A - 0.25 ) ; \qquad ( III )$$

and wherein A is the total surfactant concentration.

### BRIEF DESCRIPTION OF THE DRAWINGS

In the accompanying drawings:

FIG. 1 is an illustrative example of a front view of one possible bottom dispensing container.

FIG. 2 is a section of the bottom dispensing container of FIG. 1.

FIG. 3 is an illustrative example of a front view of another possible bottom dispensing container.

FIG. 4 an exploded view of the bottom dispensing container of FIG. 3.

FIG. 5 is a section of the bottom dispensing container of FIG. 3 showing the valve in the closed position.

FIG. 6 is a section of the valve of the bottom dispensing container of FIG. 3.

FIG. 7 is a section of the bottom dispensing container of FIG. 3 showing the valve in the open position.

FIG. 8 is an illustrative example of the bottom dispensing container illustrated in FIG. 3 being gripped by a human hand.

FIG. 9 is an illustrative example of another bottom dispensing container.

### DETAILED DESCRIPTION OF THE INVENTION

Bottom Dispensing Container—The articles of commerce of the instant invention comprise a bottom dispensing container. In one embodiment the bottom dispensing container may be at least partially, more specifically totally transparent or translucent. In another embodiment the bottom dispensing container may be at least partially, more specifically totally opaque.

In one embodiment the bottom dispensing containers include an opening on the bottom for dispensing the liquid and actuation means for dispensing the gel detergent composition. One type of bottom dispensing container is a squeeze actuated container. Squeeze containers are usually formed from a resiliently deformable material and have an opening that may have a valve to control the flow through the opening. One type of useful valve is an on-off valve that is actuated by rotating the valve. Another particularly useful valve is a pressure-responsive dispensing valve that controls the flow according to a pressure difference across the valve. Such a valve can be configured to be normally closed and to assume an open configuration when the container is squeezed. Optional features of bottom dispensing squeeze containers include a cap to prevent loss of the liquid or gel between dispensing. Bottom dispensing containers of rigid materials having pump mechanisms are also suitable for use herein.

Bottom dispensing containers have several advantages over other packaging configurations. The container does not need to be inverted, requiring fewer user motions for dispensing and providing greater positioning and dispensing control than for containers that dispense by pouring or inverting and squeezing. Thus for example, the user does not have to rotate his wrist and wait for a viscous liquid to travel to the opening, or have trouble controlling the flow rate when the container is full as in the use of containers adapted to pour from the top. Bottom dispensing containers can also be configured to allow nearly all of the liquid to be dispensed—something usually not possible with containers having a pump on the top. Bottom dispensing containers having pressure-responsive valves also have the advantage of not requiring a separate closure mechanism.

The bottom dispensing container may be made of any suitable material such as, glass, metal, polymer and the like and combinations thereof. In one embodiment the bottom dispensing container comprises a polymeric material, although other packages such as paperboard cartons with film windows and glass bottles may be used. In one embodiment the bottom dispensing container, is a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

The bottom dispensing container of the present invention may be of any form or size suitable for storing and packaging liquids for household use. For example, in one embodiment, the bottom dispensing container has a capacity, i.e. the amount of gel detergent composition that it can releasably contain therein, of from about 100 ml to about 3000 ml, more specifically from about 250 ml to about 1500 ml. In one embodiment, the bottom dispensing container is suitable for easy handling, for example the bottom dispensing container may have a handle or a part with such dimensions as to allow easy lifting or carrying the bottom dispensing container with one hand.

In another embodiment, the bottom dispensing container has a means suitable for pouring the gel detergent composition and means for reclosing the bottom dispensing container. The pouring means may be of any size or form but, preferably will be wide enough for conveniently dosing the gel detergent composition. The optional closing means may be of any form or size but usually will be screwed on, clicked on, or otherwise attached to the container to close the bottom dispensing container. The optional closing means may be cap which can be detached from the bottom dispensing container. Alternatively, the optional cap can still be attached to the bottom dispensing container, whether the bottom dispensing container is open or closed. The optional closing means may also be incorporated in the container.

In one embodiment, the bottom dispensing container is a bottom dispensing bottle.

The bottom dispensing container may be formed by any suitable process such as, thermoforming, blow molding injection-molding, or injection stretch blow molding (ISBN).

In one embodiment, the bottom dispensing container includes one or more walls, which comprise one or more layers. The layers may, if desired, be very thin, e.g., less than about 0.1 mm thick and may range to and above about 10 mm in thickness.

In another embodiment the bottom dispensing container may comprise a front and back on opposite sides of the bottom dispensing container.

Illustrative examples of suitable bottom dispensing containers may be found in U.S. Pat. No. 6,705,492, issued on Mar. 16, 2004 to Lowry; U.S. Pat. No. 4,969,581, issued on Nov. 13, 1990 to Seifert et al. U.S. Pat. No. 6,494,346, issued on Dec. 17, 2002 to Gross et al. U.S. Pat. No. 5,626,262, issued on May 6, 1997 to Fitten et al. U.S. Pat. No. 5,655,687, issued on Aug. 12, 1997 to Fitten et al. U.S. Pat. No. 4,728,006, issued on Mar. 1, 1988 to Drobish et al. U.S. Pat. No. 6,269,837, issued on Aug. 7, 2001 to Arent et al. U.S. Pat. No. 4,749,108, issued on Jun. 7, 1988 to Dornsbusch et al. U.S. Pat. No. 6,675,845, issued on Jan. 13, 2004 to Volpenheim et al. WO 92/21569 entitled “Inverted Dispenser”, published Dec. 10, 1992 in the name of Canada Inc; WO 01/04006 entitled “Container”, published Jan. 18, 2001 in the name of Unilever; EP 21,545 published Jan. 7, 1981 in the name of The Procter and Gamble Company; and EP 811,559 published Dec. 10, 1997 in the name of Unilever. Illustrative examples of bottom dispensing containers may also be found in copending U.S. Provisional Patent Application No. 60/797,975 entitled “Fabric Treatment Dispensing Package” filed on May 5, 2006 in the name of Ann De Wree, et. al, Attorney Docket Number 10403P.

It may be desirable to have a label on the container. In one embodiment, of the present invention the bottom dispensing container has one or more polymeric labels. In another embodiment the polymeric label may be opaque, translucent or transparent, and includes indicia. The term “label” is used herein in the broadest sense to include the tangible medium that may comprise one or more indicia, that may be optionally expressed including, by way of illustrative example, the placing of indicia directly onto a bottom dispensing container (e.g., printing or molding), the printing of indicia on a substrate wherein the substrate is placed on, or associated therewith, the outside surface of the bottom dispensing container, or packaging such as boxes that enclose the bottom dispensing container.

As used herein, “indicia” refers to scent, branding, packaging, properties, sound, words, phrases, letters, characters, brand names, company names, company logos or symbols, descriptions, logos, icons, designs, designer names, symbols, motifs, insignias, figures, marks, signals, colors, textures, shapes, tokens, advertisements, and combinations thereof.

In one embodiment, the indicia is selected from words, phrases, brand names, company names, descriptions, perfume names, designer names, advertisements, and combinations thereof. The indicia may be in one or more than one language.

In another embodiment, one or more indicia may be printed directly on the bottom dispensing container. In another embodiment, one or more indicia may be embossed on the container.

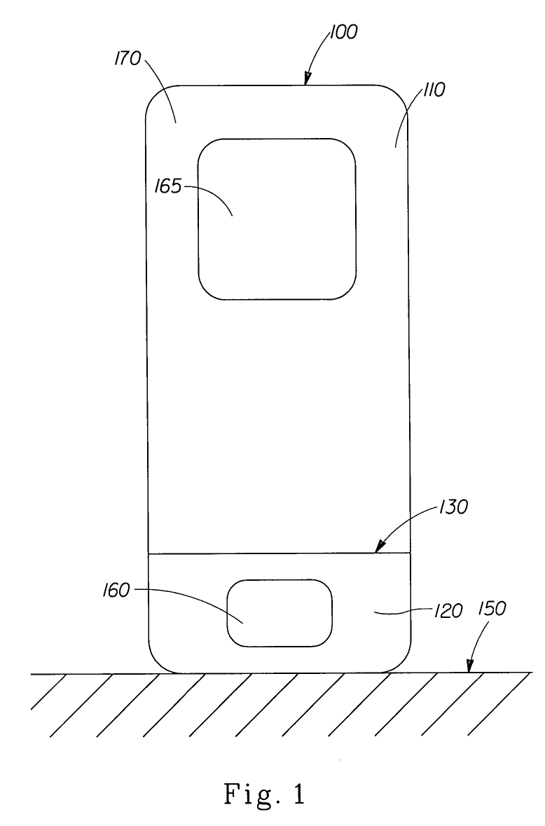

The various different and optional embodiments of the bottom dispensing container, deformable container, and/or dispensing cap may be further explained and illustrated with reference to FIGS. 1 to 9.

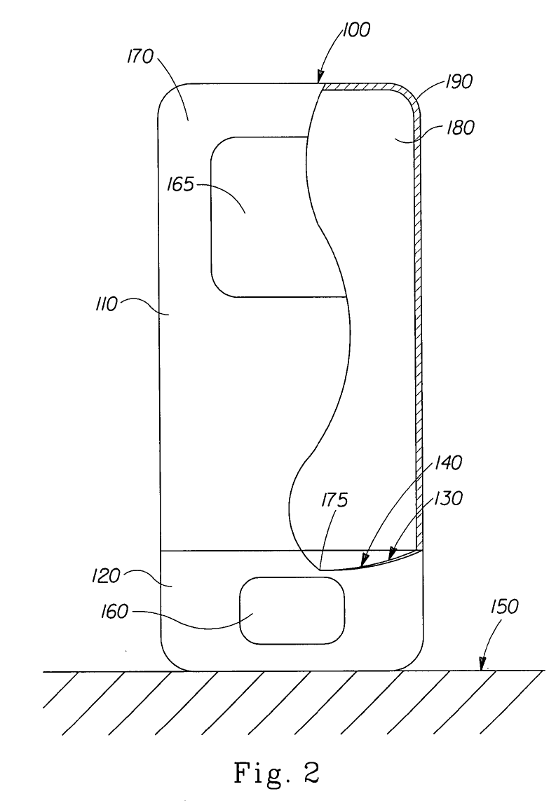

FIG. 1, is also an illustrative example of a bottom dispensing container 100, comprising a deformable container 110 and a dispensing cap 120 which is removably attached thereto. The deformable container 110 has a bottom end 130 with an opening 140 (FIG. 2) therein. The dispensing cap 120 is removably attached to the bottom end 130 of the deformable container 110 covering the opening 140. The dispensing cap 120 is also shown resting on the surface 150 in an upright position.

FIG. 1 is an illustrative example of a bottom dispensing container 100 having indicia 160 and 165 associated therewith. The indicia 160 and 165, which may be the same or different are in association with the deformable container 110 and the dispensing cap 120. In this embodiment the indicia in association therewith 160 and 165 are two labels which are fastened to the deformable container 110 and the dispensing cap 120 via adhesive.

The deformable container 110 of FIG. 1 also has a top end 170 which is distal to the bottom end 130. The deformable container 110 is also capable of resting on the surface 150 in an upright position with top end 170 contacting the surface 150, that is, now inverted with respect to the deformable container 110 as shown in FIG. 1.

As noted previously any portion of the bottom dispensing container 100 such as the deformable container 110 and/or the dispensing cap 120 can be translucent or transparent.

FIG. 2, is a section view of one possible embodiment of the bottom dispensing container 100 of FIG. 1 along line 2 of FIG. 1. This section view shows the gel detergent composition 180 and the optional valve 175, through which the gel detergent composition 180 is dispensed. Also shown is the wall 190 of the deformable container 110.

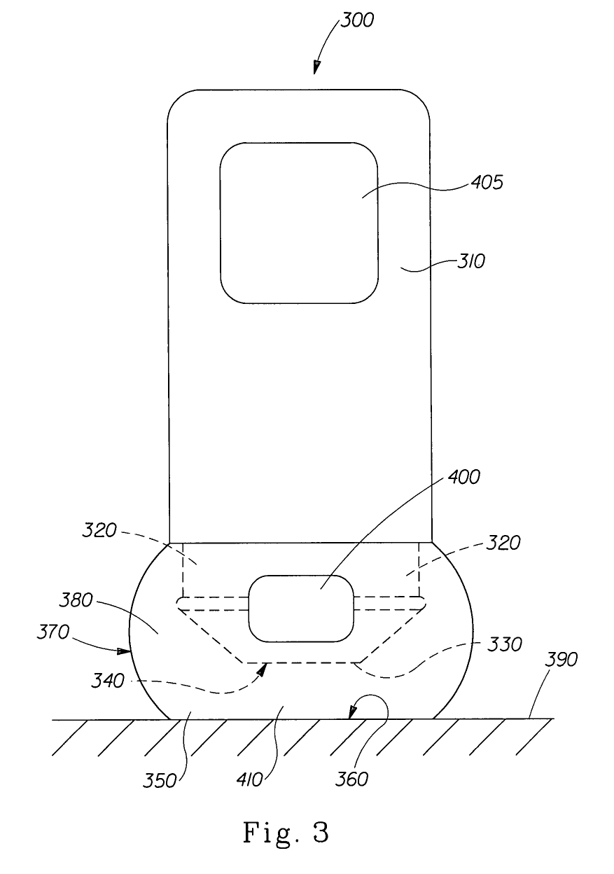

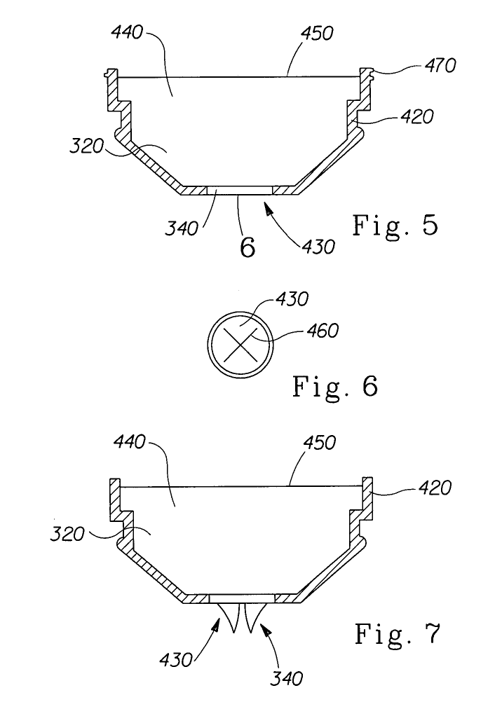

FIG. 3 is another alternative example of a bottom dispensing container 300, comprising a deformable container 310 and a dispensing cap 350 which is removably attached thereto. The deformable container 310 is attached, e.g. by snap fitting, to a dispensing end 320 having a base 330 for supporting the deformable container 310 in an upright position with a dispensing opening 340 therein. The dispensing cap 350 covers the opening 340 and the valve 430 (FIG. 5). The dispensing cap 350 supports the deformable container 310 in an upright position. The dispensing cap 350 is removably attached to the deformable container 310 over the dispensing opening 340 and covering the valve 430 and opening 340. The dispensing cap 350 is formed of a cup shaped member 410 having a face 360 and a cylindrical wall 370 which extends from the face to define an interior 380 of the dispensing cap 350. The face 360 of the dispensing cap 350 is also shown resting on the surface 390 in an upright position. The dispensing cap 350 is capable of receiving and dispensing gel composition 450 (FIG. 5), more specifically dispensing the gel composition within a washing machine.

The bottom dispensing container 300 having indicia 400 and 405 associated therewith. The indicia 400 and 405, which may be the same or different are in association with the deformable container 310 and the dispensing cap 350. In this embodiment the indicia in association therewith 400 and 405 are two labels which are fastened to the deformable container 310 and the dispensing cap 350 via adhesive.

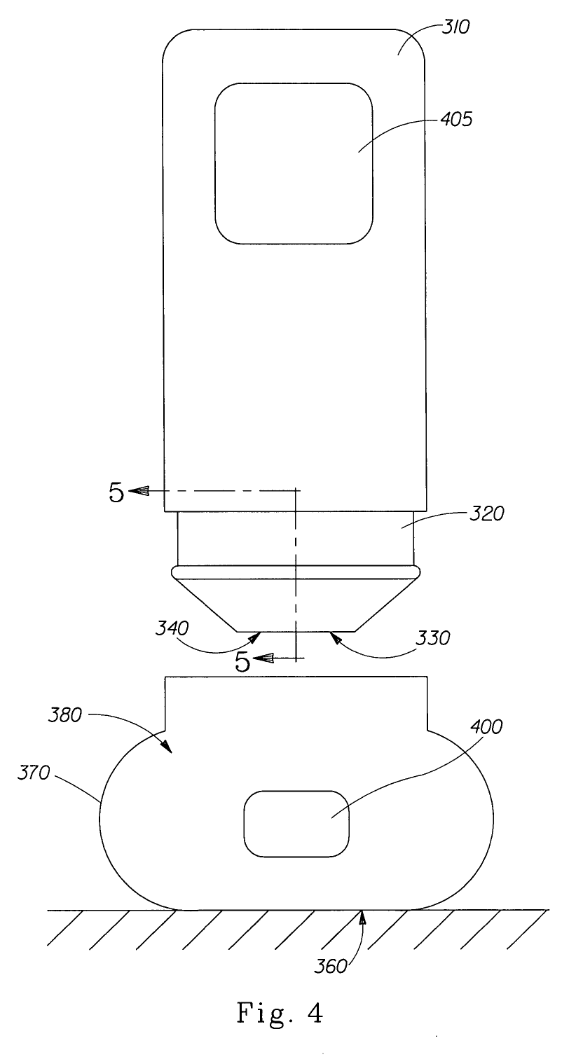

FIG. 4 is an exploded view of the bottom dispensing container 300 of FIG. 3, which shows the dispensing cap 350 as releasably attached to the deformable container 310.

FIG. 5 is a section view of one possible embodiment of the bottom dispensing container 300 of FIG. 4 along line 5. This sectional view shows the inner cavity 440 which is for storing the gel composition 450 and the optional valve 430, through which the gel composition 450 is dispensed. Also shown is the wall 420 of the deformable container 310. The valve 430 is shown in the closed position, such that gel composition 450 is prevented from flowing through the dispensing opening 340.

FIG. 6 is a section view of one possible embodiment of the valve 430 of FIG. 5 along line 6. The valve 430 has a small cross slit 460 therethrough.

FIG. 7 is a section view of one possible embodiment of the bottom dispensing container 300 of FIG. 4 along line 5. The valve 430 is shown in the open position, such that gel composition 450 is allowed to flow from the inner cavity 440 and through the dispensing opening 340.

The valve 430 in one specific optional embodiment only allows the gel composition 450 to pass through the dispensing opening 430 when it is subjected to a pressure greater than that of the gel composition 450 under normal gravity.

Alternatively, the valve 430 in another specific optional embodiment is a bimodal valve wherein the bimodal valve has a first mode of operation capable of retaining the gel composition 450 without leakage when the deformable container 310 is subjected to unintentional external forces, such as can be seen illustrated in FIG. 5, and a second mode of operation capable of dispensing the gel composition 450 when the deformable container 310 is subjected to external forces intentionally applied by a user, such as can be seen illustrated in FIG. 7.

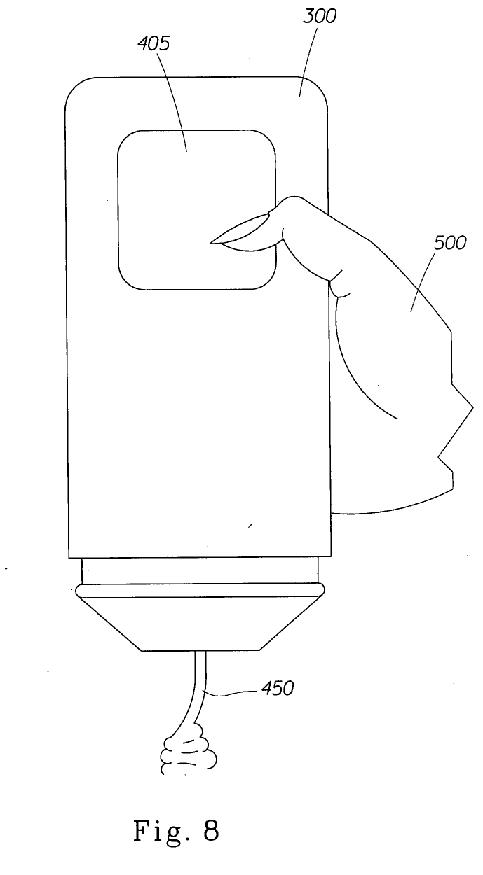

FIG. 8 is an illustrative example of the bottom dispensing container 300 of FIG. 3 being gripped by a human hand 500 and dispensing the gel composition 450. (Note: the human hand or parts thereof, are not part of the scope of the present invention).

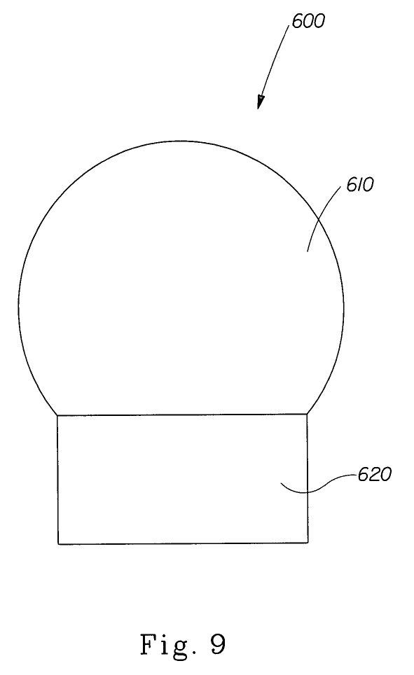

FIG. 9 is an illustrative example of another possible container. In FIG. 9, the bottom dispensing container 700 comprises a spherical deformable container 610 and a rectangular dispensing cap 620. The bottom dispensing container deformable container and dispensing cap of the present invention may be any shape.

2) Gel detergent composition—The gel detergent compositions described herein may be selected from any cleaning consumer product, such as light duty liquid detergents (hand dishwashing detergents or “LDL”), light duty detergents (“LDD”—laundry detergents designed to be used on delicate fabrics such as silks, wool and the like) heavy duty liquid laundry detergents (“HDL”), and the like, which is in the form of a gel.

“Gel” as used herein, refers to a shear thinning, lamellar gel, specifically with a pouring viscosity in the range of from about 100 to about 5,000 mPas (milli Pascal seconds), more specifically less than about 3,000 mPas, even more specifically less than about 1,500 mPas, and which also specifically has a critical shear stress higher than about 10 Pa, more specifically higher than about 15 Pa, even more specifically higher than about 20 Pa, but specifically not to exceed about 100 Pa. The concept of “gel” in the art is frequently not well defined. The most common, loose definition, however, is that a gel is a thick liquid. A thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick at low shear condition (e.g., at rest) and is thin at high flow rate condition. The rheology of shear-thinning gels may be characterized by the Sisko model:
η=a+b×\dot{γ}ⁿ⁻¹
Where: η is Viscosity, mPA s; \dot{γ} is shear rate, 1/sec; a, b are constants; and n is Sisko Rate index.

The gel detergent compositions may be of any color or shade. They may include one or more suspended phases, particles or combinations thereof. The gel detergent compositions of the invention are capable of suspending particulate solids. The solids may be undissolved electrolyte which may be the same as or different from the electrolyte in solution, the latter being saturated electrolyte. They also may be materials which are substantially insoluble in water alone. Examples of such substantially insoluble materials are aluminosilicate builders and particles of calcite abrasive.

In one embodiment, the gel detergent compositions are opaque. In another embodiment, the gel detergent compositions are translucent or transparent.

As used herein, when a composition and/or method is “substantially free” of a specific ingredient(s) it is meant that specifically none of the specific ingredient(s) is purposefully added to the composition, but yet it is understood to one of ordinary skill in the art that trace amounts of specific ingredient(s) may be present as impurities in other additives. In one embodiment, the composition contains less than about 0.1%, by weight of the composition of the specific ingredient(s).

The gel detergent compositions that are suitable for use in the bottom dispensing containers described herein are as follows.

Surfactants—In one embodiment, the gel detergent compositions of the present invention may contain one or more surface active agents (surfactants). The surfactant may be selected from anionic, nonionic, cationic, amphoteric, zwitterionic and mixtures thereof. In one embodiment, surfactants for use in the present invention are mixtures of anionic and nonionic surfactants although it is to be understood that any surfactant may be used alone or in combination with any other surfactant or surfactants. When present in the gel detergent composition, the surfactant may comprise from about 1% to about 75%, more specifically from about 5% to about 70%, by weight of the gel detergent composition.

Illustrative examples of surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, in U.S. Pat. No. 4,239,659, Murphy, issued Dec. 16, 1980, U.S. Pat. No. 4,285,841, Barrat et al, issued Aug. 25, 1981, U.S. Pat. No. 4,284,532, Leikhim et al, issued Aug. 18, 1981, U.S. Pat. No. 4,285,841, U.S. Pat. No. 3,919,678 and in U.S. Pat. Nos. 2,220,099 and 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M. C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch).

Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp.), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof. Additional, illustrative suitable nonionic surfactants are those disclosed in U.S. Pat. Nos. 4,316,812 and 3,630,929.

Nonionic surfactant, when present in the gel detergent composition may be present in the amount of from about 0.01% to about 70%, more specifically from about 1% to about 50%, even more specifically from about 5% to about 40%, by weight of the gel detergent composition.

Illustrative examples of suitable anionic surfactants includes: linear alkyl benzene sulfonates (e.g. Vista C-500 commercially available from Vista Chemical Co.), branched linear alkyl benzene sulfonates (e.g. MLAS), alkyl sulfates (e.g. Polystep B-5 commercially available from Stepan Co.), branched alkyl sulfates, polyoxyethylenated alkyl sulfates (e.g. Standapol ES-3 commercially available from Stepan Co.), alpha olefin sulfonates (e.g. Witconate AOS commercially available from Witco Corp.), alpha sulfo methyl esters (e.g. Alpha-Step MCp-48 commercially available from Stepan Co.) and isethionates (e.g. Jordapon Cl commercially available from PPG Industries Inc.), and combinations thereof.

Anionic surfactant, when present in the gel detergent composition may be present in the amount of from about 0.01% to about 70%, more specifically from about 1% to about 50%, even more specifically from about 5% to about 40%, by weight of the gel detergent composition.

Specific cationic surfactants which can be used as surfactants in the subject invention are described in detail in U.S. Pat. No. 4,497,718. Specific cationic surfactants include C8-C18 alkyl dimethyl ammonium halides and analogs in which one or two hydroxyethyl moieties replace one or two methyl moieties.

Cationic surfactant, when present in the gel detergent composition, may be present in the amount of from about 0.01% to about 70%, more specifically from about 1% to about 50%, even more specifically from about 5% to about 40%, by weight of the gel detergent composition.

Examples of amphoteric surfactants are sodium 3(dodecylamino)propionate, sodium 3-(dodecylamino)propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine.

Amphoteric surfactant, when present in the gel detergent composition may be present in the amount of from about 0.01% to about 70%, more specifically from about 1% to about 50%, even more specifically from about 5% to about 40%, by weight of the gel detergent composition.

Examples of zwitterionic surfactants which may be used herein are set forth in U.S. Pat. No. 4,062,647.

Zwitterionic surfactant, when present in the gel detergent composition may be present in the amount of from about 0.01% to about 70%, more specifically from about 1% to about 50%, even more specifically from about 5% to about 40%, by weight of the gel detergent composition.

Non-neutralized Fatty acid—Any fatty acid is suitable for use herein, including but not limited to lauric, myristic, palmitic stearic, oleic, linoleic, linolenic acid, and mixtures thereof, more specifically selected from fatty acid which would not form a crispy solid at room temperature. Naturally obtainable fatty acids, which are usually complex mixtures, are also suitable (such as tallow, coconut, and palm kernel fatty acids). The preferred fatty acid is oleic acid because it is a liquid at room temperature and its C18 chain helps to induce lamellar phase. Furthermore, it is also a builder and after neutralization, it can offer good detergency.

The amount of non-neutralized fatty acid depends on the amount of surfactant employed, and whether or not the gel detergent composition piles up upon dispensing, has a snap index value and/or a gelling index as described herein. In one embodiment, the amount of non-neutralized fatty acid is in the range of from about 0.1% to about 5%, more specifically from about 0.2% to about 4%, even more specifically from about 0.5 to about 3%, by weight of the composition.

For the avoidance of doubt, the following pKa values may be employed in the present invention to calculate the amount of non-neutralized fatty acid in the compositions:

Table of pKa Value of Fatty acids*

| Fatty acid chain length | pKa value |
|---|---|
| 8 | 6.3-6.5 |
| 10 | 7.1-7.3 |
| 12 | 7.5 |
| 14 | 8.1-8.2 |
| 16 | 8.6-8.8 |
| 16** | 8.5 |

*Cited from Langmuir, Vol 16, pp 172A177, 2000 (J. R. Kanicky, A. F. Poniatowski, N. R. Mehta, and D. O. Shah);
**Proc. R. Soc. London, A133, 140, 1931 (R. A. Peters).

It is to be understood that commercially available fatty acids, such as industrial grade Coco acid, are mixtures of fatty acids. The difference in alkyl chain length in such a mixture of fatty acids, while not wishing to be limited by theory, is believed to weaken the Van der Waals interaction between fatty acid molecules, and resulting in a reduction in pKa value as compared with the pure fatty acid.

Pile Up Detergent—In one embodiment the gel detergent compositions piles up upon dispensing, more specifically the weight ratio of said non-neutralized fatty acid to the surfactant is less than about 1 but greater than or equal to the Pileup Index Value, P defined by the equation (I)
P=0.35−(0.01×A) (I)
and wherein A is the total surfactant concentration. A, the total surfactant, does not include the amount of non-neutralized anionic surfactant precursors, but does include fully neutralized fatty acid soap surfactant. If the weight ratio is greater than 1, the surfactant system may not solubilize all non-neutralized fatty acid and phase separation results. If the weight ratio is less than the Pile-up Value, P, the gel with the desired pile-up might not form.

In another embodiment the gel detergent composition which piles up upon dispensing comprises:
(a) from about 10% to about 35%, more specifically from about 10% to about 25%, even more specifically from about 10% to about 20%, by weight of the composition, of a surfactant,
(b) from about 0.1% to about 5%, by weight of the composition; of a non-neutralized fatty acid;
(c) from about 50% to about 85% of water;
(d) wherein the total of anionic surfactants selected from soap, linear alkyl benzene sulfonic acid, primary and secondary alkyl sulfates is more than about 50%, more specifically more than about 60%, even more specifically more than about 70% of total surfactant level.

The gel detergent compositions according to this embodiment offer an advantage of laundry pretreater and a detergent in a single product.

In one embodiment the surfactant comprises mixtures of linear alkyl aryl sulfonates (LAS) and alkoxylated (e.g., ethoxylated) sulfates (LES) with alkoxylated nonionics the weight ratio of 2:1:1. In another embodiment the surfactant comprises a mixture of anionic surfactant to nonionic surfactant in a weight ratio of 1:1.

Non-drip Gel detergent—In one embodiment the gel detergent is a non-drip gel detergent, more specifically the wherein the weight ratio of non-neutralized fatty acid to surfactant is less than about 1 but greater than or equal to the Snap Index Value, S, defined by equation (II)
S=0.3−(0.0085×A) (II)
wherein A is, as defined herein. If the weight ratio is greater than 1, the surfactant system may not solubilize all non-neutralized fatty acid and phase separation results. If the weight ratio is less than the Snap Index Value, S, the gel does not have a snap back property.

A non-drip gel detergent is one which has snap- back property, i.e. they snap back, like a spring released from extension, upon the end of dispensing. In one embodiment this property may be characterized by G′ the elastic (storage) modulus, more specifically, a liquid or gel which has G′ greater than 10 Pa exhibits snap-back (no drip) property. Higher G′ signifies that the liquid or gel has a virtual high Hook constant spring built in. Thus, at the pouring stage the virtual spring is extended and it bounced back when the pouring is stopped.

In another embodiment the gel detergent composition which snaps back at the end of dispensing, thus eliminating or minimizing the dripping from the bottom dispensing container comprises
(a) from about 8% to about 35%, more specifically from about 10% to about 25%, even more specifically still from about 10% to about 20%, by weight of the composition, of a surfactant;
(b) from about 0.1% to about 5%, by weight of the composition; of a non-neutralized fatty acid;
(c) from about 40 to about 90% of water;
(d) wherein the weight % ratio of the non-neutralized fatty acid to the surfactant is less than about 1 but greater than or equal to the Snap Index Value, S, defined by equation (II)
   S=0.3−(0.0085×A) (II)
   wherein A is, as defined herein.

In one embodiment the gel detergent comprises a hydrotrope, more specifically selected from propylene glycol and/or glycerin.
Gelling Index Value—In one embodiment the gel detergent has a weight % ratio of non-neutralized fatty acid to surfactant of less than about 1 but greater than or equal to the Gelling Index Value GIV, defined by equation (III),

$$GIV = \frac{0.75}{1 + {( 0.11 ⨯ A )}^{8.3}} - ( 0.0062 ⨯ A - 0.25 ) . \qquad ( III )$$

wherein A is, as defined herein. If the weight % ratio is greater than 1, the surfactant system may not solubilize all non-neutralized fatty acid and phase separation results. If the ratio is less than the Gelling Index Value, GIV, the gel does not form.

In another embodiment the gel detergent composition is a gel laundry detergent and/or pretreater composition and comprises:
(a) from about 8% to about 35%, more specifically from about 10% to about 25%, even more specifically from about 10% to about 20%, by weight of the composition, of a surfactant selected from the group consisting of anionic, nonionic cationic, amphoteric surfactants and mixtures thereof;
(b) from about 0.1% to about 5%, by weight of the composition; of a non-neutralized fatty acid;
(c) from about 50 to about 90% of water;
(d) wherein the weight % ratio of the non-neutralized fatty acid to the surfactant is less than about 1 but greater than or equal to the Gelling Index Value, GIV, defined by equation (III)

$$GIV = \frac{0.75}{1 + {( 0.11 ⨯ A )}^{8.3}} - ( 0.0062 ⨯ A - 0.25 ) . \qquad ( III )$$

and wherein A is, as defined herein.

Additional information on the Sisko model, shear thinning, pouring viscosity, lamellar, lamellar gels, the storage elastic modulus G′ and G′ may be found in U.S. Pat. Nos. 6,815,409, 6,849,587, and 6,794,348.

Optional Ingredients—Any of the gel detergent composition described herein may comprise one or more optional ingredients.

Water—The gel detergent compositions according to the present invention may also optionally contain a liquid carrier, in one embodiment water. Typically the amount of the liquid carrier when present in the compositions herein will be relatively large, often comprising the balance of the cleaning composition, but can comprise from about 5 wt % to about 85 wt % by weight of the cleaning composition. In one embodiment low levels, about 1% to about 50% by weight of the cleaning composition of liquid carrier is utilized.

The most cost effective type of aqueous, non-surface active liquid carrier is, of course, water itself. In one embodiment, the water is selected from distilled, deionized, filtered and combinations thereof. In another optional embodiment, the water may be untreated.

The liquid carrier herein may also contain low levels of materials which serve as phase stabilizers and/or co-solvents for the compositions herein. Materials of this type include C₁-C₃ lower alkanols such as methanol, ethanol and/or propanol. Lower C₁-C₃ alkanolamines such as mono-, di- and triethanolamines can also be used, by themselves or in combination with the lower alkanols. If present, phase stabilizers/co-solvents can optionally comprise from about 0.1% to about 5.0% by weight of the compositions herein.

Aesthetics—The gel detergent composition and the bottom dispensing container may have any desired appearance or aesthetics. The gel detergent composition and the bottom dispensing container may be opaque, transparent or translucent, of any color or appearance, such as a pearlescent liquid. In one embodiment, the gel detergent composition may contain air or gas bubbles, suspended liquid droplets, simple or multiple emulsion droplets, suspended particles and the like and combinations thereof. Suitable sizes include from about 0.1 microns to about 5 mm, even more specifically from about 20 microns to about 1 mm. These optional suspended liquids and/or particles may be visible as discrete entities, i.e. different color, shape, texture, and the like and combinations thereof. These suspended liquids and/or particles may be a different color, texture or some other visually distinguishing feature than the other portions of the gel detergent composition.

Additionally, the gel detergent composition and the bottom dispensing container may be any color or combination of colors. It is also to be understood that the term “color” not only includes all the colors of the visible spectrum, namely, red, orange, yellow, green, blue, teal, brown, purple, lilac, sea green, tan, navy, violet, pink and the like, it also includes all shades, tones, hues and the like, such as dark blue, light, blue, light green, etc, of these colors, as well as black, white, and grey and all shades, tones, hues and the like of these. Furthermore, the gel detergent composition and the bottom dispensing container may also in addition have any additional visual treatments, such as for example, a combination of varied refractive indices, pearlescence, opalescence, reflective, holographic effect, metallic color, gloss finish, matte finish and the like and combinations thereof.

In another embodiment the gel detergent composition may comprise two or more visually distinctive regions. Each region can itself comprise one or more distinct physical phases. The term “visually distinctive” as used herein describes compositions in the bottom dispensing container or upon being dispensed that display visually different regions. These different regions are either distinctively separate or partially mixed as long as the gel detergent composition remains visible to the naked eye. The combination of these visually distinctive regions can be chosen to produce any of a wide variety of patterns, including for example: striped, marbled, rectilinear, interrupted striped, check, mottled, veined, clustered, speckled, geometric, spotted, ribbons, helical, swirl, arrayed, variegated, textured, grooved, ridged, waved, sinusoidal, spiral, twisted, curved, cycle, streaks, striated, contoured, anisotropic, laced, weave or woven, basket weave, spotted, and tessellated. The pattern may be striped and may be relatively uniform and even across the dimension any bottom dispensing container. Alternatively, the striped pattern may be uneven, i.e. wavy, or may be non-uniform in dimension. The striped pattern does not need to necessarily extend across the entire dimension of any bottom dispensing container.

The term “stripe” as used herein means that each phase present in the gel detergent composition occupies separate but distinct physical spaces inside the bottom dispensing container in which it is stored, but are in direct contact with one another. (i.e. they are not separated by a barrier and they are not emulsified or mixed to any significant degree). The stripes may be relatively uniform and even across the dimension of the bottom dispensing container. Alternatively the stripes may be uneven, i.e. wavy, or may be non-uniform in dimension. The stripes do not necessarily extend across the entire dimension of the bottom dispensing container. The “stripe” can comprise various geometric patterns, various colors and, or glitter or pearlescence, providing that the concentration of these forms visually distinct bands or regions.

The term “marbling” as used herein refers to a striped design with a veined and/or mottled appearance similar to marble.

While many variations in the physical characteristics of the components are possible, i.e., color, viscosity, rheology, texture, density etc, variations in color are widely sought. The specific design or pattern achieved (i.e., width, length of stripe or marbling etc.) in the gel detergent composition can be varied by varying a number of factors for example, rheological characteristics of the phases, diameter of the dispensing means, presence or absence of rotation of the container during filling, rate of speed and constancy and the like and combinations thereof.

Adjunct Ingredients—The gel detergent composition may comprise one or more adjunct ingredients to give it additional desired properties, of functional and/or aesthetic nature.

The compositions and methods described herein may include an adjunct ingredient, specifically from about 0.0001% to about 95%, even more specifically from about 0.001% to about 70%, by weight of the gel detergent composition, of an adjunct ingredient.

In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers, enzymes, soil suspending agents, anti-redeposition agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. Further examples of suitable adjunct ingredient and levels of use are described in U.S. Pat. No. 3,936,537, issued Feb. 3, 1976 to Baskerville, Jr. et al.; U.S. Pat. No. 4,285,841, Barrat et al., issued Aug. 25, 1981; U.S. Pat. No. 4,844,824 Mermelstein et al., issued Jul. 4, 1989; U.S. Pat. No. 4,663,071, Bush et al.; U.S. Pat. No. 4,909,953, Sadlowski, et al. issued Mar. 20, 1990; U.S. Pat. No. 3,933,672, issued Jan. 20, 1976 to Bartoletta et al.; U.S. Pat. No. 4,136,045, issued Jan. 23, 1979 to Gault et al. U.S. Pat. No. 2,379,942; U.S. Pat. No. 3,308,067; U.S. Pat. No. 5,147,576 to Montague et al. British Pat. No. 1,470,250; British Patent No. 401,413 to Marriott; British Patent No. 461,221 to Marriott and Guam British Patent No. 1,429,143; and U.S. Pat. No. 4,762,645, Tucker et al, issued Aug. 9, 1988.)

Nonlimiting examples of some of possible adjunct ingredients follows.

Examples of suitable chelants include, S,S-ethylenediamine disuccinic acid (EDDS), Tiron® (otherwise know as Catechol-2,5-disulfonate as the acid or water soluble salt), ethylenediamine tetraacetic acid (EDTA), Diethylenetriaminepentaacetate (DTPA), 1-Hydroxyethylidene 1,1 diphosphonic acid (HEDP), Diethylenetriamine-penta-methylene phosphonic acid (DTPMP), dipicolinic acid and salts and/or acids thereof and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Examples of suitable builders which may be used include water-soluble alkali metal phosphates, polyphosphates, borates, silicates and also carbonates; water-soluble amino polycarboxylates; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, citric acid, and carboxymethyloxysuccinic acid, salts of polymers of itaconic acid and maleic acid, tartrate monosuccinate, tartrate disuccinate.

Enzymes which may be used in this invention are described in greater detail below. In one embodiment the optional enzyme when present may be selected from protease, cutinase, hemicellulase, peroxidases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, lactase, amylase and mixtures thereof.

A non-limiting list of suitable commercially available enzymes include: Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ^{˜}43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes eventually with enhancers include e.g. peroxidases, laccases, oxygenases, (e.g. catechol 1,2 dioxygenase, lipoxygenase (WO 95/26393), (non-heme) haloperoxidases . Suitable proteases include, Alcalase®, Savinase®, Kannase®, Everlase®, Esperase® available from Novozymes; Purafect®, Purafext Ox®, Properase® available from Genencor; BLAP and BLAP variants available from Henkel; Maxatase and Maxacal of Gist-Brocades; Kazusase of Showa Denko; and K-16-like proteases available from KAO. Additional illustrative proteases are described in e.g. EP130756, WO91/06637, WO95/10591, WO99/20726, U.S. Pat. No. 5,030,378 (Protease “A”) and EP251446 (Protease “B”).

Hydrotropes may be added to the gel detergent compositions. Hydrotrope reduces and prevents liquid crystal formation, and more specifically hydrotropes may be optionally present in the gel detergent compositions. Illustrative hydrotropes include propylene glycol, glycerin, ethanol, urea, salts of benzene sulphonate, toluene sulphonate, xylene sulphonate, cumene sulphonate and mixtures there of. Illustrative salts include to sodium, potassium, ammonium, monoethanolamine, triethanolamine and mixtures thereof. In one embodiment the hydrotrope is selected from propylene glycol, glycerin, xylene sulfonate, ethanol, urea and combinations thereof. In one embodiment the amount of the optional hydrotrope may be in the range of from about 0 to about 15%, more specifically from about 0.1 to 8%, even more specifically from about 0.2 to about 6%, even more specifically still from about 0.5 to about 3%.

One optional adjunct ingredient is a pH jump system (e.g., boron compound/polyol), as described in the U.S. Pat. No. 5,089,163 and 4,959,179 to Aronson et al. The inclusion of the pH jump system ensures that the pH jumps up in the washing machine to neutralize fatty acid, so as to obtain the benefits of neutralized fatty acid and to minimize surfactant amount.

In one embodiment the gel detergent compositions are substantially free (i.e. contain less than about 1%, even more specifically less than about 0.5%, even more specifically still less than about 0.1% of) of traditional thickening agents, such as cross-linked polyacrylates, polysaccharide gums (e.g. xantham), gellan, pectin, carrageenan, gelatin. However, in other specific alternative embodiment these traditional thickening agents may be used.

The list of optional ingredients above is not intended to be exhaustive and other optional ingredients which may not be listed, but are well known in the art, may also be included in the composition.

Transparent or translucent—As used herein, “translucent or transparent” refers to a transmittance of greater than about 25% transmittance of at least one wavelength of electromagnetic radiation in the visible spectrum (approx. 410-800 nm), more specifically a transmittance of more than about 25%, even more specifically more than about 30%, even more specifically still more than about 40%, yet even more specifically still more than about 50% in the visible part of the electromagnetic spectrum wherein % transmittance equals:

$$\frac{1}{{10}^{absorbancy}} ⨯ 100 \% .$$

Alternatively, a container, composition and the like may be considered translucent or transparent if the absorbency of the bottle of the visible electromagnetic spectrum is less than about 0.6. An illustrative example of a translucent or transparent object would be a clear bottle or clear composition. Another example of a translucent or transparent object would be a bottle or composition which is colored, such having a blue or red tint, but still has a transmittance of greater than about 25% transmittance of at least one wavelength of electromagnetic radiation in the visible spectrum.

In one embodiment, the gel detergent composition is transparent or translucent and has a transmittance of at least about a 50% transmittance of light using a 1 cm cuvette at wavelengths of about 410 nanometers to about 800 nanometers.

Additional illustrative information and examples of translucent or transparent and opaque containers and/or compositions and the like can be found in U.S. Pat Nos. 6,630,437 issued to Murphy et al. 6,756,350 issued to Giblin et al. 6,631,783 issued to Giblin et al. and 6,159,958 issued to Bae-Lee et al.

As used herein, “opaque” refers to a transmittance of less than about 25% transmittance of all wavelengths of electromagnetic radiation in the visible spectrum, more specifically a transmittance of less than about 20%, even more specifically less than about 15%, even more specifically still less than about 10%, yet even more specifically still less than about 5% in the visible part of the electromagnetic spectrum. Alternatively, a container, composition and the like may be considered opaque if the absorbency of the bottle of the visible electromagnetic spectrum is greater than about 0.6.

Methodology—Measurement of Absorbency and Transmittance—Instrument: Milton Roy Spectronic 601

Procedure:

1. Both the spectrophotometer and the power box were turned on and allowed to warm up for 30 minutes.
2. Set the wavelength: Type in the desired wavelength on the keypad (i.e., 590, 640, etc.). Press the [second function] key. Press the “go to λ” [yes] key. The machine is then ready to read at the chosen wavelength.
3. Zero the instrument: Press the [second function] key. Press the “zero A” [% T/AIC]. Instrument should then read “XXX NM 0.000 A T”
4. Open the cover, place sample vertically and in front of the sensor.
5. Close the lid and record reading (ex. 640 NM 0.123 A T)

Note: All readings are taken in “A” mode (absorbency mode). Zero instrument with every new wavelength change and/or new sample.

Absorbency Values for Two Typical Plastic Bottles

| Wavelength | Polyethylene (HDPE) | Polypropylene (PP) |
|---|---|---|
| (in nm) | 0.960 mm thickness | 0.423 mm thickness |
| 254 (non-visible) | 1.612 | 1.886 |
| 310 (non-visible) | 1.201 | 0.919 |
| 360 (non-visible) | 0.980 | 0.441 |
| 590 (visible) | 0.525 | 0.190 |
| 640 (visible) | 0.477 | 0.169 |

Use of the Composition—The gel detergent compositions may be used as laundry cleaning products (e.g., a laundry detergent, and/or a laundry pretreater). The gel detergent compositions, more specifically those gel detergents that pile up upon dispensing, offer an advantage of laundry pretreater and a detergent in a single product. In use, a measured amount of the composition is deposited on the laundry or in the laundry washing machine, whereupon mixing with water, the cleaning of laundry is affected. It should be noted that due to the presence of non-neutralized fatty acid in the compositions, the compositions are low foaming and are particularly suitable for the use in front-loading laundry machines.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

Except as otherwise noted, the articles “a,” “an,” and “the” mean “one or more.” All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article of commerce for storing and dispensing gel compositions comprising:
(a) a bottom dispensing container; and
(b) a gel detergent composition, releasably stored in said bottom dispensing container, wherein said gel detergent composition comprises:
(i) a surfactant; and
(ii) a non-neutralized fatty acid;
wherein said gel detergent composition piles up upon dispensing.

2. The article of commerce according to claim 1 wherein the weight ratio of said non-neutralized fatty acid to said surfactant is less than about 1 but greater than or equal to the Pileup Index Value, P defined by the equation (I)
P=0.35−(0.1×A) (I)
wherein A is the total surfactant concentration.

3. The article of commerce according to claim 1 wherein the total amount of surfactant is less than about 25% by weight of the composition.

4. The article of commerce according to claim 1 wherein said bottom dispensing container is transparent or translucent.

5. The article of commerce according to claim 1 wherein the critical shear stress of the composition is higher than about 10 Pa.

6. The article of commerce according to claim 1 wherein said gel detergent composition comprises an adjunct ingredient selected from builders, brighteners, dye transfer inhibitors, structurants, chelants, polyacrylate polymers, dispersing agents, dyes, perfumes, processing aids, bleaching agents, bleach activators, bleach catalysts, solvents, enzymes, soil release polymers, and mixtures thereof.

7. The article of commerce according to claim 1 wherein transparent or translucent bottom dispensing container is a polymeric material selected from polypropylene, polyethylene, polycarbonate, polyamide, polyethylene terephthalate, polyvinylchloride, polystyrene, and mixtures thereof.

8. An article of commerce for storing and dispensing gel compositions comprising:
(a) a bottom dispensing container; and
(b) a non-drip gel detergent composition, releasably stored in said bottom dispensing container, wherein said gel detergent composition comprises:
(i) a surfactant; and
(ii) a non-neutralized fatty acid;
wherein the weight ratio of non-neutralized fatty acid to said surfactant is less than about 1 but greater than or equal to the Snap Index Value, S, defined by equation (II)
S=0.3−(0.0085×A) (II)
wherein A is the total surfactant concentration.

9. The article of commerce according to claim 8 wherein the total amount of surfactant is less than about 25% by weight of the composition.

10. The article of commerce according to claim 8 wherein said composition is transparent or translucent.

11. The article of commerce according to claim 8 wherein said bottom dispensing container is transparent or translucent.

12. The article of commerce according to claim 8 wherein the composition has a storage (elastic) modulus value G′ of greater than about 10 Pa.

13. The article of commerce according to claim 8 wherein transparent or translucent bottom dispensing container is a polymeric material selected from polypropylene, polyethylene, polycarbonate, polyamide, polyethylene terephthalate, polyvinylchloride, polystyrene, and mixtures thereof.

14. An article of commerce for storing and dispensing gel compositions comprising:
(a) a bottom dispensing container; and
(b) a gel detergent composition, releasably stored in said bottom dispensing container, wherein said gel detergent composition comprises:
(i) a surfactant; and
(ii) a non-neutralized fatty acid;
wherein the weight % ratio of non-neutralized fatty acid to said surfactant is less than about 1 but greater than or equal to the Gelling Index Value, GIV, defined by equation (III)
$$GIV = \frac{0.75}{1 + {( 0.11 ⨯ A )}^{8.3}} - ( 0.0062 ⨯ A - 0.25 )$$
wherein A is the total surfactant concentration.

15. The article of commerce according to claim 14 wherein the total amount of surfactant is less than about 25% by weight of the composition.

16. The article of commerce according to claim 14 wherein said surfactant comprises a mixture of anionic surfactants and nonionic surfactants.

17. The article of commerce according to claim 14 wherein said composition is transparent or translucent.

18. The article of commerce according to claim 14 wherein said bottom dispensing container is transparent or translucent.

19. An array of laundry products comprising at least two of the articles of commerce according to claim 14.

20. A method of treating fabric comprising at least the step of squeezing the article of commerce according to claim 14 to enable contacting of said fabric with the composition.
